(19) United States
(12) Patent Application Publication
(10) Pub. No.: US 2010/0149044 A1
(43) Pub. Date: Jun. 17, 2010

(54) SMALL-SIZED ANTENNA

(75) Inventors: Tiao-Hsing Tsai, Yunghe City (TW); Chun-Ren Lin, Niaosong Township (TW); Chi-Yin Fang, Pingtung City (TW); Chih-Wei Liao, Su-ao Township (TW)

Correspondence Address: HAMMER & ASSOCIATES, P.C., 3125 SPRINGBANK LANE, SUITE G, CHARLOTTE, NC, 28226, US

(73) Assignee: Quanta Computer Inc.

(21) Appl. No.: 12/430,925

(22) Filed: Apr. 28, 2009

(30) Foreign Application Priority Data
Dec. 15, 2008 (TW) 097148750

(51) Int. Cl. H01Q 1/38

(52) U.S. Cl. 343/700 MS

(57) ABSTRACT

An antenna includes first and second dielectric substrates, a grounding element, and a radiating unit. The first dielectric substrate extends on a horizontal plane. The grounding element is formed on the first dielectric substrate. The second dielectric substrate extends on a vertical plane transverse to the horizontal plane and is disposed on the first dielectric substrate. The radiating unit is formed on the second dielectric substrate, and is provided with a feeding point, and a grounding point coupled to the grounding element.

### CROSS-REFERENCE TO RELATED APPLICATION

This application claims priority of Taiwanese Application No. 097148750, filed on Dec. 15, 2008.

### BACKGROUND OF THE INVENTION

1. Field of the Invention

This invention relates to an antenna, more particularly to a small-sized antenna for a global positioning system (GPS) communications device.

2. Description of the Related Art

FIG. 1 illustrates a conventional antenna 91 for a global positioning system (GPS) communications device 9. The conventional antenna 91 extends on a horizontal plane, i.e., on the x-y plane, and hence achieves a substantially hemispherical radiation pattern and good signal transmission and reception in the z-direction. The conventional antenna 91, however, has a relatively large size.

### SUMMARY OF THE INVENTION

Therefore, the object of the present invention is to provide a small-sized antenna.

According to the present invention, an antenna comprises first and second dielectric substrates, a grounding element, and a radiating unit. The first dielectric substrate extends on a horizontal plane and has a surface. The grounding element is formed on the first dielectric substrate. The second dielectric substrate extends on a vertical plane transverse to the horizontal plane and is disposed on the surface of the first dielectric substrate. The radiating unit is formed on the second dielectric substrate, and is provided with a feeding point, and a grounding point coupled to the grounding element.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional antenna installed in a global positioning system (GPS) communications device;

FIG. 2 is a perspective view of the preferred embodiment of an antenna according to the present invention;

FIG. 3 is a schematic view illustrating a grounding element, a feeding element, an extension, and a coupling element of the preferred embodiment;

FIG. 4 is a schematic view illustrating a first radiating element of the preferred embodiment;

FIG. 5 is a schematic view illustrating a second radiating element of the preferred embodiment;

FIGS. 6 to 9 are schematic views illustrating dimensions, in millimeter, of the preferred embodiment;

FIG. 10 is a plot illustrating a voltage standing wave ratio (VSWR) of the preferred embodiment; and

FIG. 11 are plots illustrating radiation patterns of the preferred embodiment on the x-y, z-x, and y-z planes when operated at 1575 MHz.

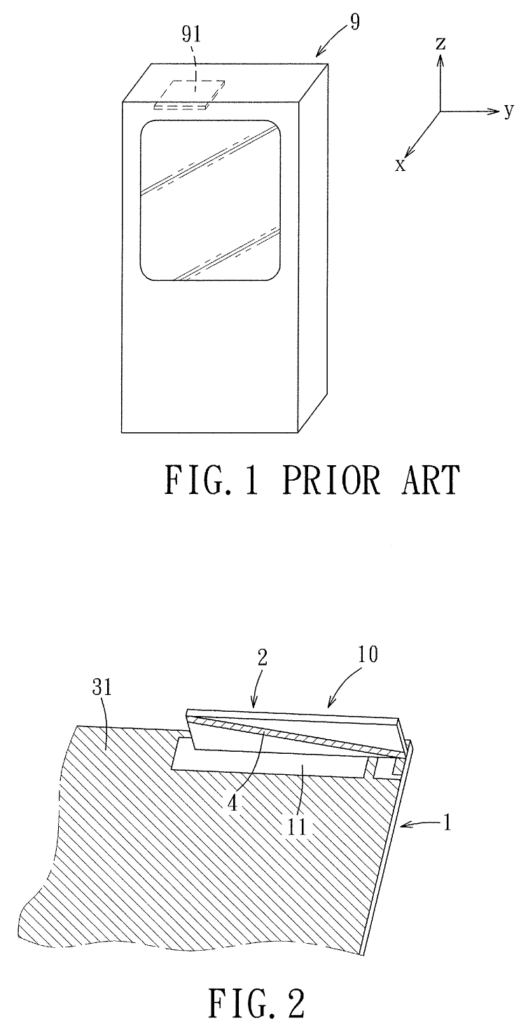

### DETAILED DESCRIPTION OF THE PREFERRED EMBODIMENT

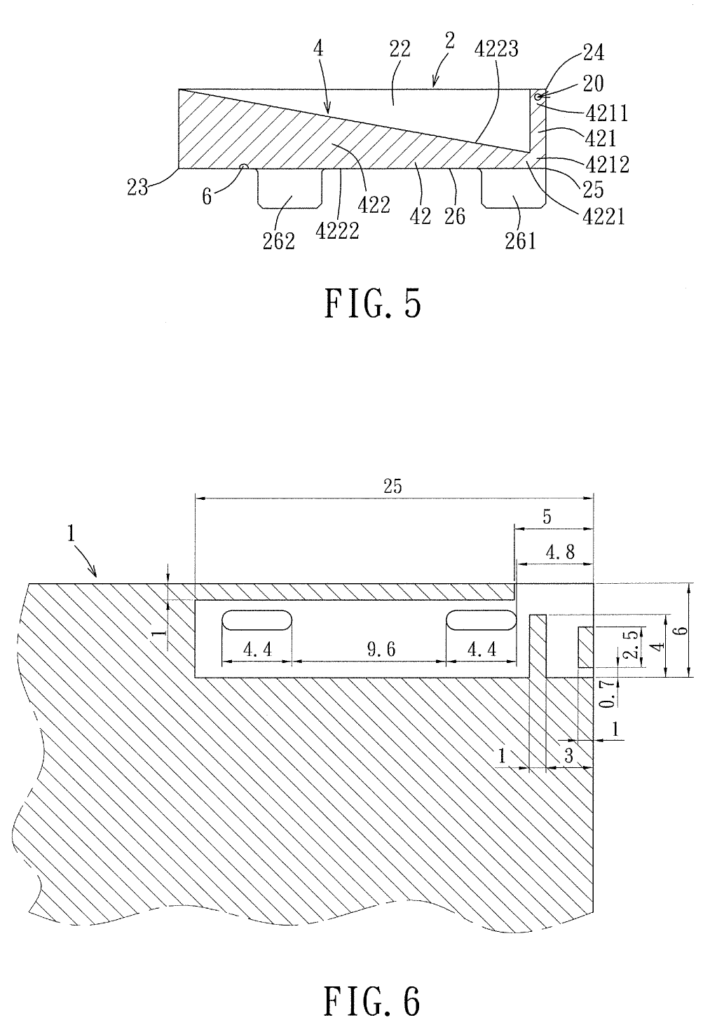

Referring to FIGS. 2 to 5, the preferred embodiment of an antenna 10 according to this invention is shown to include first and second dielectric substrates 1, 2, a grounding element 31, and a radiating unit 4.

The antenna 10 in this embodiment is applicable to a global positioning system (GPS) communications device (not shown) and operates at a GPS carrier frequency, i.e., 1575.42±1.023 MHz.

The first dielectric substrate 1 extends on a horizontal plane, and has a surface 11 that has an end 111.

The grounding element 31 is formed on the surface 11 of the first dielectric substrate 1 and is connected to an electrical ground (not shown).

The antenna 10 further includes a feeding element 32, an extension 33, and a coupling element 34, each of which is formed on the surface 11 of the first dielectric substrate 1 and is in the form of a strip. The feeding element 32 is connected to a signal source (not shown) of the GPS communications device via a feeding line (not shown). The extension 33 extends from the grounding element 31 toward the end 111 of the surface 11 of the first dielectric substrate 1. The coupling element 34 extends from the grounding element 31 along the end 111 of the surface 11 of the first dielectric substrate 1 and is parallel to the second dielectric substrate 2.

In an alternative embodiment, the GPS communications device includes a plurality of electronic components (not shown) that are mounted on the first dielectric substrate 1, and a plurality of traces (not shown) that are formed on the first dielectric substrate 1 and that interconnect the electronic components.

The second dielectric substrate 2 extends on a vertical plane transverse to the horizontal plane, has opposite first and second surfaces 21, 22, is generally rectangular in shape, and has a horizontal edge 26 disposed on the surface 11 of the first dielectric substrate 1, and a first corner 23 adjacent to the horizontal edge 26, and a second corner 24 opposite to the first corner 23.

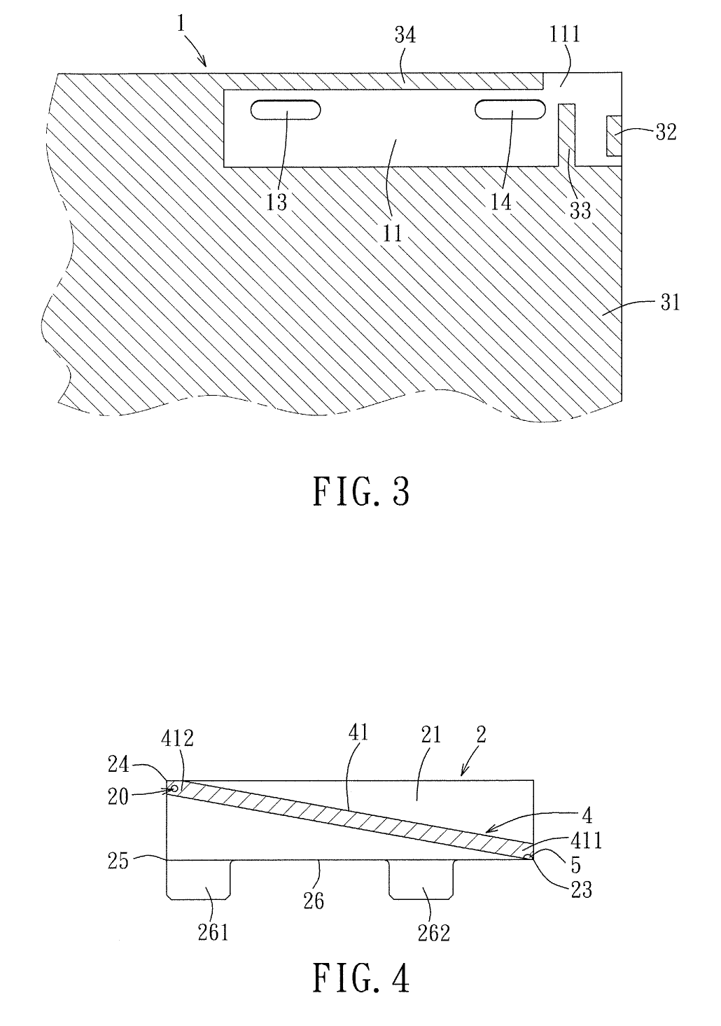

In this embodiment, the first dielectric substrate 1 is formed with a pair of slots 13, 14, as best shown in FIG. 3, and the horizontal edge 26 of the second dielectric substrate 2 is provided with a pair of inserts 261, 262, as best shown in FIG. 4, each of which is inserted in a respective one of the slots 13, 14.

The radiating unit 4 includes first and second radiating elements 41, 42, each of which is formed on a respective one of the first and second surfaces 21, 22 of the second dielectric substrate 2.

The first radiating element 41 of the radiating unit 4 is formed on the first surface 21 of the second dielectric substrate 2, is in the form of a strip, extends from the first corner 23 to the second corner 24 of the second dielectric substrate 2, and has a first end 411 disposed at the first corner 23 of the second dielectric substrate 2, and a second end 412 disposed at the second corner 24 of the second dielectric substrate 2. In this embodiment, the first end 411 of the first radiating element 41 of the radiating unit 4 is provided with a feeding point 5 connected, i.e., soldered, to the feeding element 32.

The second dielectric substrate 2 further has a third corner 25 adjacent to the horizontal edge 26 and the first and second corners 23, 24 thereof.

The second radiating element 42 of the radiating unit 4 includes first and second segments 421, 422. The first segment 421 of the second radiating element 42 is in the form of a strip, extends from the second corner 24 to the third corner 25 of the second dielectric substrate 2, and has a first end 4211 disposed at the second corner 24 of the second dielectric substrate 2, and a second end 4212 disposed at the third corner 25 of the second dielectric substrate 2.

The antenna 10 further includes a via unit 20. The first end 4211 of the first segment 421 of the second radiating element 42 is coupled to the second end 412 of the first radiating element 41 through the via unit 20.

The second segment 422 of the second radiating element 42 is generally triangular in shape, and has a corner 4221, and horizontal and inclined sides 4222, 4223 adjacent to the corner 4221. The corner 4221 of the second segment 422 of the second radiating element 42 extends from the second end 4212 of the first segment 421 of the second radiating element 42. The horizontal side 4222 of the second segment 422 of the second radiating element 42 is flush with the horizontal edge 26 of the second dielectric substrate 2. In this embodiment, the second segment 422 of the second radiating element 42 of the radiating unit 4 is provided with a grounding point 6 connected, i.e., soldered, to the extension 33.

It is noted herein that the coupling element 34 is disposed proximate to the second radiating element 42 of the radiating unit 4. As such, a coupling effect is generated between the coupling element 34 and the second radiating element 42, thereby permitting operation of the radiating unit 4 at the GPS carrier frequency and reducing a size of the radiating unit 4.

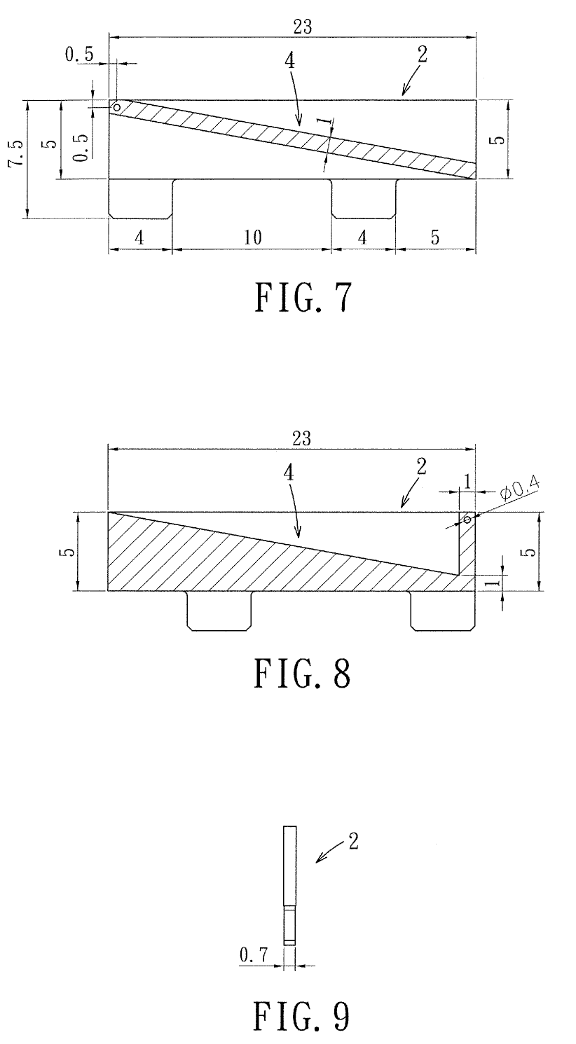

As illustrated in FIGS. 6 to 9, the second dielectric substrate 2 of the antenna 10 of this invention indeed has a relatively small size.

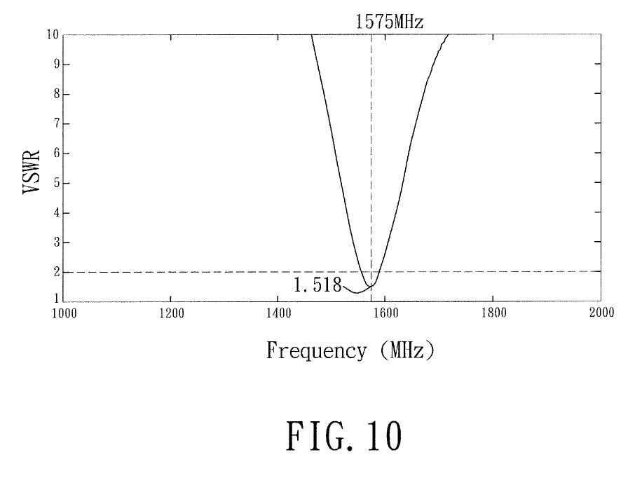

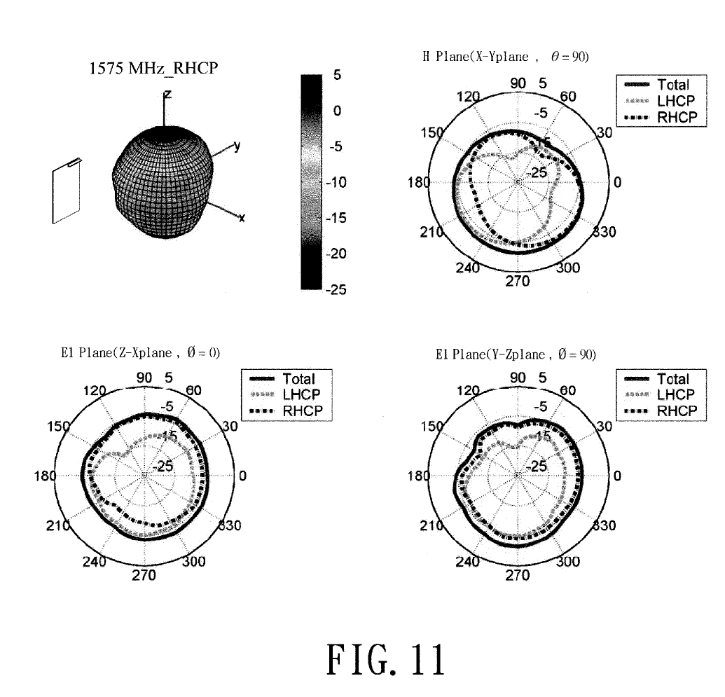

Experimental results, as illustrated in FIG. 10, show that the antenna 10 of this invention achieves a voltage standing wave ratio (VSWR) of less than 2, i.e., 1.518, when operated at 1575 MHz. Moreover, as illustrated in Table I below, the antenna 10 of this invention achieves a zenith gain of −5.2 dBic and an average gain of at least −6.4 dBic. Further, as illustrated in FIG. 11, the antenna 10 of this invention has substantially omnidirectional radiation patterns on the x-y, z-x, and y-z planes when operated 1575 MHz. As such, the antenna 10 of this invention has a substantially hemispherical radiation pattern and good signal transmission and reception in the z-direction.

TABLE I

| FOV (elevation) | Zenith gain (dBic) | Avg. Gain (dBic) |
|---|---|---|
| 0° to 75° | −5.2 | −4.9 |
| 0° to 90° | −5.2 | −5.2 |
| 0° to 120° | −5.2 | −5.7 |
| 0° to 180° | −5.2 | −6.4 |

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna, comprising:
a first dielectric substrate extending on a horizontal plane and having a surface;
a grounding element formed on said first dielectric substrate;
a second dielectric substrate extending on a vertical plane transverse to the horizontal plane and disposed on said surface of said first dielectric substrate; and
a radiating unit formed on said second dielectric substrate, and provided with a feeding point, and a grounding point coupled to said grounding element.

2. The antenna as claimed in claim 1, wherein said first dielectric substrate is formed with a slot, and said second dielectric substrate is provided with an insert inserted into said slot.

3. The antenna as claimed in claim 1, further comprising:
a feeding element formed on said surface of said first dielectric substrate and coupled to said feeding point.

4. The antenna as claimed in claim 3, wherein said feeding element is soldered to said feeding point.

5. The antenna as claimed in claim 1, further comprising:
an extension which is formed on said surface of said first dielectric substrate and through which said grounding point is coupled to said grounding element.

6. The antenna as claimed in claim 5, wherein said grounding point is soldered to said extension.

7. The antenna as claimed in claim 1, wherein said second dielectric substrate has opposite first and second surfaces, said radiating unit including
a first radiating element formed on said first surface of said second dielectric substrate and provided with said feeding point, and
a second radiating element formed on said second surface of said second dielectric substrate, provided with said grounding point, and coupled to said first radiating element.

8. The antenna as claimed in claim 7, further comprising a via unit through which said second radiating element is coupled to said first radiating element.

9. The antenna as claimed in claim 7, wherein said first radiating element is in the form of a strip.

10. The antenna as claimed in claim 7, wherein said second dielectric substrate further has a horizontal edge disposed on said surface of said first dielectric substrate, said second radiating element including
a first segment that has opposite first and second ends, said first end of said first segment being coupled to said first radiating element, and
a second segment that is provided with said grounding point, that is generally triangular in shape, and that has a corner, and horizontal and inclined sides, which are adjacent to said corner, said corner of said second segment extending from said second end of said first segment, said horizontal side of said second segment being flush with said horizontal edge of said second dielectric substrate.

11. The antenna as claimed in claim 10, wherein said first segment of said second radiating element is in the form of a strip.

12. The antenna as claimed in claim 10, wherein said second dielectric substrate further has a first corner adjacent to said horizontal edge, and a second corner opposite to said first corner,
said first radiating element extending from said first corner to said second corner of said second dielectric substrate, and having a first end which is disposed at said first corner of said second dielectric substrate and which is provided with said feeding point, and a second end which is disposed at said second corner of said second dielectric substrate and which is coupled to said first end of said first segment of said second radiating element.

13. The antenna as claimed in claim 12, wherein said second dielectric substrate further has a third corner adjacent to said horizontal edge and said first and second corners thereof,
said first segment of said second radiating element extending from said second corner to said third corner of said second dielectric substrate.

14. The antenna as claimed in claim 7, further comprising:
a coupling element formed on said surface of said first dielectric substrate, extending from said grounding element, and disposed proximate to said second radiating element.

15. The antenna as claimed in claim 14, wherein said surface of said first dielectric substrate has an end along which said coupling element extends.
